(19) United States
(12) Patent Application Publication
(10) Pub. No.: US 2024/0192039 A1
(43) Pub. Date: Jun. 13, 2024

(54) DOWNHOLE FLOW-METER

(71) Applicant: Saudi Arabian Oil Company, Dhahran (SA)

(72) Inventors: Bander Al Quaimi, Al Khobar (SA); Hassan W. Al Hashim, Dammam (SA); Basmah Al Otaibi, Dhahran (SA)

(21) Appl. No.: 18/080,509

(22) Filed: Dec. 13, 2022

(51) Int. Cl. G01F 15/00; E21B 47/10; G01F 1/10

(52) U.S. Cl. CPC G01F 15/006; E21B 47/10; G01F 1/10

(57) ABSTRACT

A downhole flowmeter assembly includes a main body configured to be disposed in a wellbore and a spinner assembly comprising a hub from which radially extends a plurality of pitched blades. The hub is configured to rotate in response to a flow of wellbore fluid across the blades, and a velocity of the flow can be determined from a speed of rotation of the hub. The assembly also includes an oleophobic coating disposed at least partially on the hub and the plurality of pitched blades.

### TECHNICAL FIELD

This disclosure relates to measurement of fluid flow in a well.

### BACKGROUND

Downhole flowmeters are frequently employed to determine a rate of fluid flow in a wellbore. A common type of flowmeter is a spinner-type flowmeter, by which a velocity of fluid flow is determined by a speed of rotation of a spinner (sometimes called an impeller) positioned within the flowing fluid. The angular rotation speed (typically in revolutions per second) is related to the product of the fluid density and the fluid velocity, where the fluid velocity is further used to determine flow rate.

### SUMMARY

Certain aspects of the subject matter herein can be implemented as a downhole flowmeter assembly. The assembly includes a main body configured to be disposed in a wellbore and a spinner assembly comprising a hub from which radially extends a plurality of pitched blades. The hub is configured to rotate in response to a flow of wellbore fluid across the blades, and a velocity of the flow can be determined from a speed of rotation of the hub. The assembly also includes an oleophobic coating disposed at least partially on the hub and the plurality of pitched blades.

An aspect combinable with any of the other aspects can include the following features. The oleophobic coating can include poly (diallyldimethylammonium).

An aspect combinable with any of the other aspects can include the following features. The oleophobic coating can include poly (styrene sulfonate).

An aspect combinable with any of the other aspects can include the following features. The oleophobic coating can include particles with sizes of less than about 100 nanometers.

An aspect combinable with any of the other aspects can include the following features. The downhole flowmeter assembly of claim 1, wherein the oleophobic coating can include particles of about 1 nanometer in size.

An aspect combinable with any of the other aspects can include the following features. Each blade of the plurality of pitched blades can be cambered.

An aspect combinable with any of the other aspects can include the following features. Each blade of the plurality of pitched blades can be hydrofoil shaped.

An aspect combinable with any of the other aspects can include the following features. Each blade of the plurality of blades can have a thickness of less than about 0.8 millimeters.

An aspect combinable with any of the other aspects can include the following features. The hub can be a nose tip of the spinner assembly.

An aspect combinable with any of the other aspects can include the following features. The downhole flowmeter assembly of claim 8, wherein the hub can be the upstream-most portion of the spinner assembly.

An aspect combinable with any of the other aspects can include the following features. An upstream-most portion of the hub can have a spherically blunted conic shape.

An aspect combinable with any of the other aspects can include the following features. An upstream-most portion of the hub can include a conic shroud connected to, and that rotates with, a main body of the hub.

An aspect combinable with any of the other aspects can include the following features. The hub and the plurality of pitched blades can together comprise a one-piece unit.

An aspect combinable with any of the other aspects can include the following features. Each of the plurality of pitched blades can be separate units attached to the hub.

An aspect combinable with any of the other aspects can include the following features. The spinner assembly can be a first spinner assembly of a plurality of spinner assemblies, each attached to a deployable arm attached to the main body, and the downhole flowmeter assembly can be configured to, when the deployable arm is deployed, array the plurality of spinner assemblies vertically, thereby exposing each spinner assembly of the plurality of spinner assemblies to a respective horizontal layer of the flow of wellbore fluid.

Certain aspects of the subject matter herein can be implemented as a method. The method includes disposing, in a wellbore, a downhole flowmeter assembly. The assembly includes a main body configured to be disposed in a wellbore, and a spinner assembly comprising a hub from which radially extends a plurality of pitched blades. The hub is configured to rotate in response to a flow of wellbore fluid across the blades. The assembly further includes an oleophobic coating disposed at least partially on the hub and the plurality of pitched blades. The method also includes determining, from a speed of rotation of the blades, a velocity of the flow.

An aspect combinable with any of the other aspects can include the following features. The method can also include disposing the oleophobic coating on the hub and the plurality of pitched blades.

An aspect combinable with any of the other aspects can include the following features. The oleophobic coating can include poly (diallyldimethylammonium).

An aspect combinable with any of the other aspects can include the following features. The oleophobic coating can include poly (styrene sulfonate).

An aspect combinable with any of the other aspects can include the following features. The oleophobic coating can include particles with sizes of less than about 100 nanometers.

An aspect combinable with any of the other aspects can include the following features. The oleophobic coating can include particles of about 1 nanometer in size.

### DESCRIPTION OF DRAWINGS

FIG. 1 is a schematic illustration of a downhole flowmeter assembly in accordance with embodiments of the present disclosure.

FIGS. 2A, 2B, and 2C are schematic illustration of a spinner assembly and spinner in accordance with embodiments of the present disclosure.

FIG. 3 is a process flowchart of an example of a method for determining a velocity of wellbore fluid flow in accordance with embodiments of the present disclosure.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Wellbore fluids flowing through such wells (particularly highly-deviated and horizontal wells) can be multiphase in character and can include fluids of different densities and compositions, including water, oil, and/or gas, and can include entrained solids or solid and organic materials such as alphaltes, maltenes, and emulsions. Such materials can attach to or otherwise accumulate on spinner components as sludges, resulting in diminished measurement accuracy, shorter tool life, and other undesirable effects.

Multiphase fluids can be frequently encountered in highly deviated and horizontal wells. In some circumstances, an operator may deploy a multiphase flowmeter tool configured such that a plurality of spinners are deployed in the fluid flow, arrayed vertically so as to measure the flow rates of fluids of flowing in horizontal layers of different densities. Undesirable material accumulation can be a particular problem in operation of such multi-spinner flowmeter assemblies.

In accordance with embodiments of the present disclosure, the hub and blades of a spinner assembly of a downhole flowmeter assembly can include a coating of a non-stick oleophobic material to reduce the tendency of sludges of organic materials to accumulate on spinner components. Such coating can, in some embodiments, include a nano-material. In some embodiments of the present disclosure, a spinner hub can be conical in shape and comprise a nose tip of the spinner assembly with blade shapes to further reduce undesirable material accumulation. In some embodiments, such improved spinner assemblies can be employed in multi-spinner tools used to measure multiphase flow. Reducing or eliminating undesirable material accumulation on spinner assemblies can result in improved and more cost-efficient wellbore operations.

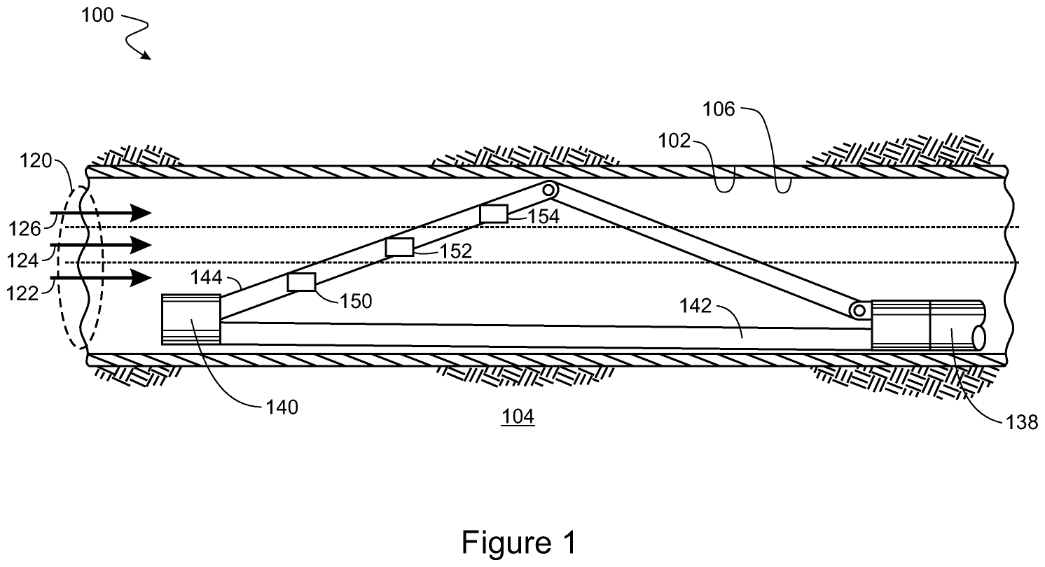

FIG. 1 is a schematic illustration of a downhole flowmeter assembly in a wellbore system accordance with an embodiment of the present disclosure. Referring to FIG. 1, wellbore system 100 includes a wellbore 102 drilled into a subterranean zone 104. In the illustrated embodiment, wellbore 102 is production wellbore of an oil and gas production well and is partially lined with a casing 106. Some or all of wellbore 102 can be horizontal, vertical, or have another orientation. In other embodiments of the present disclosure, wellbore 102 can be an injection wellbore. Wellbore fluids 120 flow through the wellbore. In the illustrated embodiment, wellbore fluids 120 are multiphase and include layers 122, 124, and 126 of fluids of different densities (for example, water, oil and gas, respectively). Multiphase fluid flow can include fewer or greater layers and can comprise turbulent flow or other flow or composition characteristics such that the density layers may not be fully distinct.

Downhole flowmeter assembly 140 is disposed within wellbore 102, conveyed by coiled tubing 138 or another suitable conveyance. Flowmeter assembly 140 includes a main body 142 and a deployable arm 144. Flowmeter assembly 140 can be raised or lowered uphole or downhole, and can be configured in a first, undeployed configuration (not shown) in which deployable arm 144 is not deployed and folded against main body 142. When the assembly reaches the desired downhole location, the assembly can be configured in a second, deployed configuration as shown in FIG. 1 in which deployable arm 144 extends from the main body, thereby arraying spinner assemblies 150, 152, and 154 within the wellbore (for example, vertically). Flowmeter assembly 140 in the illustrated embodiment includes three spinner assemblies; other embodiments may include a greater or lesser number of spinner assemblies. In the illustrated embodiment, the configuration of deployed arm 144 is such that the spinner assemblies are exposed to different horizontal layers of fluid flow, i.e., spinner assembly 150 within fluid layer 122, spinner assembly 152 within fluid layer 124, and spinner assembly 154 within fluid layer 126. As described in further detail below, each of the spinner assemblies 150, 152, and 154 includes a spinner (a rotating hub with blades extending radially therefrom and attached to a shaft) that rotates in response to the fluid flow, and the speed of this rotation can, in turn, be used to calculate fluid velocity in accordance with traditional methods.

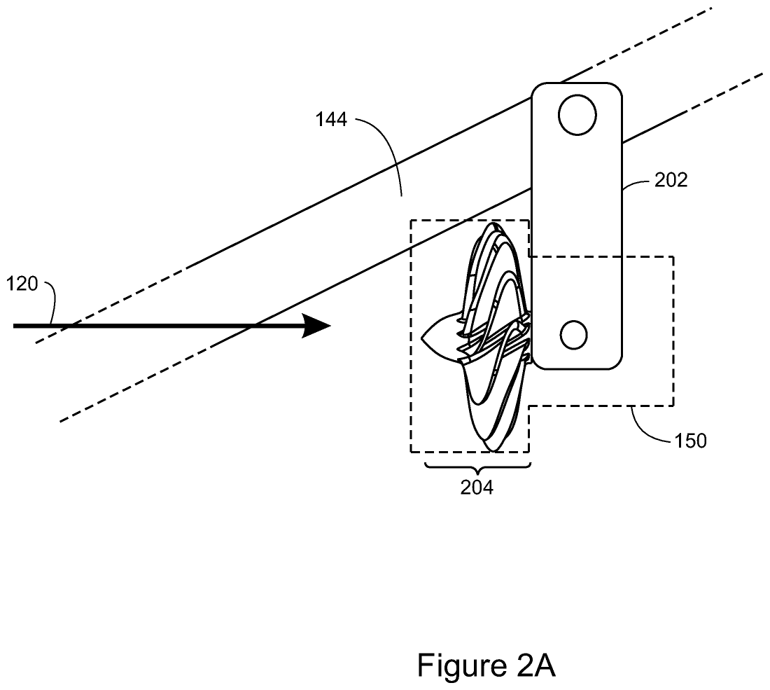

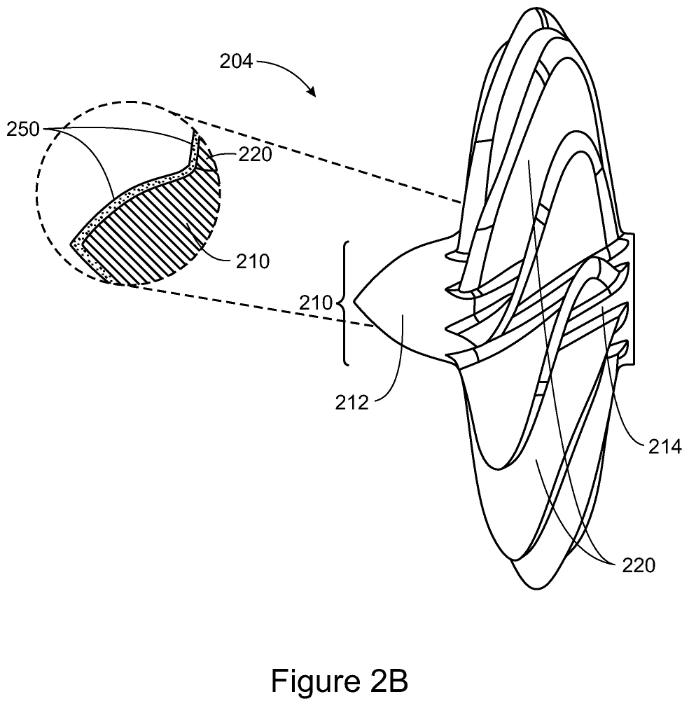

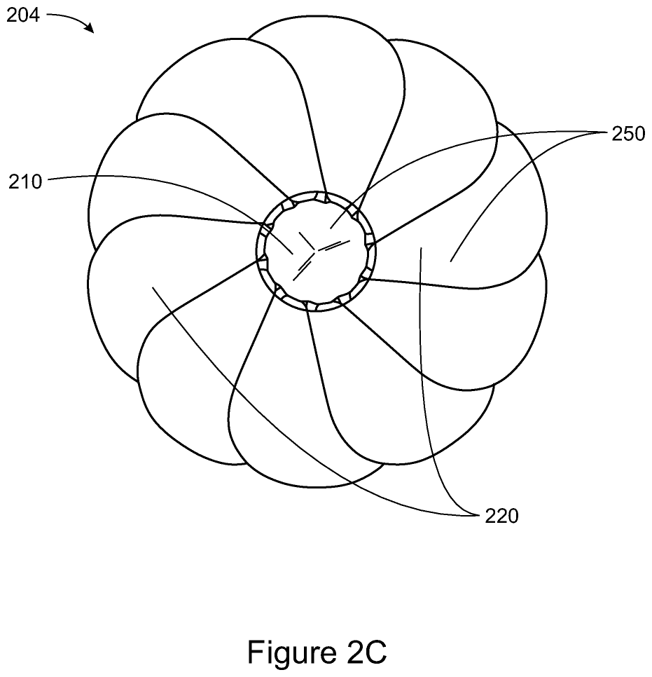

FIGS. 2A, 2B, and 2C are schematic illustration of a spinner assembly and spinner in accordance with an embodiment of the present disclosure. FIG. 2A illustrates spinner assembly 150 of FIG. 1, attached to deployable arm 144 by a support 202 in accordance with some embodiments of the present disclosure, exposed to the flow of fluid 120. Spinner assembly 150 in the illustrated embodiment includes (as shown in FIG. 2A) a spinner 204 which in turn includes (as shown in FIG. 2B) a plurality of pitched blades 220 extending radially from a rotating hub 210. FIG. 2C is a front-on perspective of spinner 204 in accordance to an embodiment of the present disclosure. Spinner assembly 150 and flowmeter assembly 140 can include conventional measurement and communication devices to allow an operator to determine fluid flow velocity from rotation of hub 210. It will be understood that spinner assemblies 152 and 154 of flowmeter assembly 140 of FIG. 1 can in some embodiments have the same or different components and configurations as shown in FIGS. 2A, 2B, and 2C, and that flowmeter assemblies in some embodiments can include additional spinner assemblies or multiple spinner assemblies of the same or different configurations as shown in FIGS. 2A, 2B, and 2C.

In the illustrated embodiment, as shown in FIG. 2B, an oleophobic coating 250 is at least partially disposed on (that is, at least partially covers the exterior surfaces of) hub 210 and pitched blades 220. Oleophobic coating 250 can in some embodiments reduce or eliminate the adhesion of organic sludge and other materials on spinner 204 and spinner assembly 150. In some embodiments, oleophobic coating 250 comprises poly (diallyldimethylammonium) (PDDA). Instead of or in addition, in some embodiments, oleophobic coating 250 comprises poly (styrenesulfonate) (PSS). Instead or in addition, oleophobic coating 250 can include other chemicals with similar properties or structures. Coating 250 can be applied as one layer, two layers, or a greater number of uniform layers, and can be applied uniformly and cured after deposition with an anionic agent. In some embodiments, coating 250 can comprise alternating layers of PDDA and PSS. In some embodiments, oleophobic coating 250 is, or includes, a nanomaterial with particles of PDDA, PSS, and/or other compositions with sizes of between about 1 nanometer and about 100 nanometers.

In the illustrated embodiment, as shown in FIG. 2A, spinner 204 is the nose tip of spinner assembly 150. That is, spinner 204 is itself the upstream-most portion of spinner assembly 150. Such a configuration—with the spinner 204 itself comprising the upstream-most portion of spinner assembly—can further reduce or inhibit sludge accumulation and can require fewer parts than conventional downhole flowmeter spinner assemblies (in which the spinner is connected at both the front and back ends to its support). In the illustrated embodiment, as shown in FIG. 2B, hub 210 has a forward (upstream) portion (212) with spherically blunted conic shape and a main body 214 having a barrel shape. In some embodiments, hub 210 is a one-piece construction comprising forward portion 212 and main body 214. In other embodiments, hub 210 can comprise multiple pieces. For example, in some embodiments, forward portion 212 of the hub can is a separate conic shroud that is connected to (and therefore rotates with) the barrel-shaped main body 214. In some embodiments, hub 210 and blades 220 are a one-piece unit. In some embodiments, each of the plurality of pitched blades are separate units attached to hub 210. Blades 220 can, in some embodiments, be comprised of a reinforced, heat-resistant plastic, carbon fiber, and/or metal.

Blades 220 can be sized and configured to as to eliminate or reduce the adhesion of sludge on the spinner and spinner assembly. In some embodiments, spinner 204 can have three blades or four blades. In other embodiments, spinner 204 can have a greater or lesser number of blades. In some embodiments, pitched blades 220 can each be in the shape of a hydrofoil or airfoil, and/or can be cambered (curved). In some embodiments, pitched blades 220 can be skewed blades. In some embodiments, pitched blades 220 can have a pitch of approximately forty (40) degrees; other embodiments can include blades of greater or lesser pitch. In some embodiments, the blades can have a thickness of less than about 0.8 millimeters. In some embodiments, pitched blades 220 can have a length of about 1 centimeter and a width of about 0.5 centimeters. In some embodiments, spinner 204 can have a diameter of about 2.3 centimeters. In some embodiments, hub 210 can have a diameter of about 0.5 centimeters.

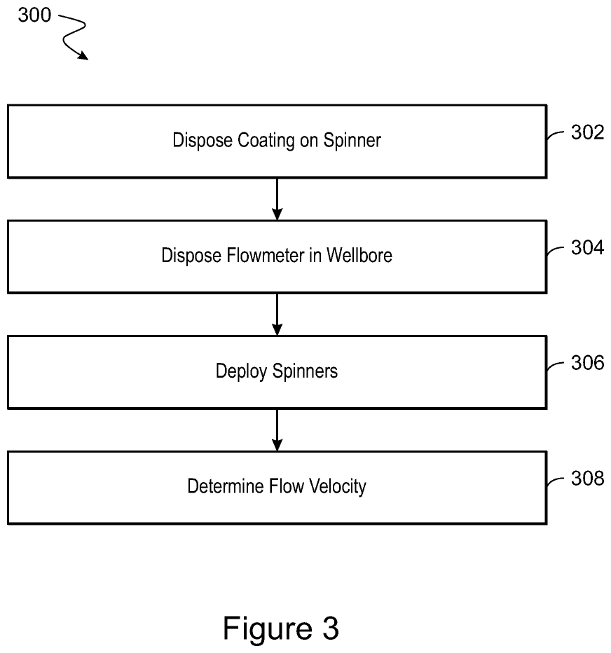

FIG. 3 is a process flowchart of an example of a method for determining a velocity of wellbore fluid flow in accordance with an embodiment of the present disclosure. At step 302, an oleophobic coating, such as oleophobic coating 250, as described above is disposed on the blades and hub of a spinner or spinners, and the spinners attached to a spinner assembly of a downhole flowmeter assembly, such as flowmeter assembly 140. At step 304, the flowmeter is disposed in a wellbore. At step 306, if the flowmeter assembly has a multi-spinner, deployable arm configuration as shown in FIG. 1, the arm is deployed, exposing the spinners to the layers of fluid flow. At step 308, the velocity of fluid flow and flow rate is determined based on the speed of rotation of the spinner or spinners.

The term “uphole” as used herein means in the direction along a wellbore from its distal end towards the surface, and “downhole” as used herein means the direction along a wellbore from the surface towards its distal end. A downhole location means a location along a wellbore downhole of the surface.

A number of implementations of the disclosure have been described. Nevertheless, it will be understood that various modifications may be made without departing from the spirit and scope of the disclosure.

What is claimed is:

1. A downhole flowmeter assembly, the downhole flowmeter assembly comprising:
a main body configured to be disposed in a wellbore;
a spinner assembly comprising a hub from which radially extends a plurality of pitched blades, the hub configured to rotate in response to a flow of wellbore fluid across the blades, wherein a velocity of the flow can be determined from a speed of rotation of the hub; and
an oleophobic coating disposed at least partially on the hub and the plurality of pitched blades.

2. The downhole flowmeter assembly of claim 1, wherein the oleophobic coating comprises poly (diallyldimethylammonium).

3. The downhole flowmeter assembly of claim 1, wherein the oleophobic coating comprises poly (styrene sulfonate).

4. The downhole flowmeter assembly of claim 1, wherein the oleophobic coating comprises particles with sizes of less than about 100 nanometers.

5. The downhole flowmeter assembly of claim 1, wherein the oleophobic coating comprises particles of about 1 nanometer in size.

6. The downhole flowmeter assembly of claim 1, wherein each blade of the plurality of pitched blades is cambered.

7. The downhole flowmeter assembly of claim 1, wherein each blade of the plurality of pitched blades is hydrofoil shaped.

8. The downhole flowmeter assembly of claim 1, wherein each blade of the plurality of blades has a thickness of less than about 0.8 millimeters.

9. The downhole flowmeter assembly of claim 1, wherein the hub is a nose tip of the spinner assembly.

10. The downhole flowmeter assembly of claim 9, wherein the hub comprises an upstream-most portion of the spinner assembly.

11. The downhole flowmeter assembly of claim 9, wherein an upstream-most portion of the hub has a spherically blunted conic shape.

12. The downhole flowmeter assembly of claim 9, wherein an upstream-most portion of the hub comprises a conic shroud connected to, and that rotates with, a main body of the hub.

13. The downhole flowmeter assembly of claim 9, wherein the hub and the plurality of pitched blades together comprise a one-piece unit.

14. The downhole flowmeter assembly of claim 1, wherein each of the plurality of pitched blades are separate units attached to the hub.

15. The downhole flowmeter assembly of claim 1, wherein the spinner assembly is a first spinner assembly of a plurality of spinner assemblies, each attached to a deployable arm attached to the main body, and wherein the downhole flowmeter assembly is configured to, when the deployable arm is deployed, array the plurality of spinner assemblies vertically, thereby exposing each spinner assembly of the plurality of spinner assemblies to a respective horizontal layer of the flow of wellbore fluid.

16. A method comprising:
disposing, in a wellbore, a downhole flowmeter assembly, the downhole flowmeter assembly comprising:
a main body configured to be disposed in a wellbore;
a spinner assembly comprising a hub from which radially extends a plurality of pitched blades, the hub configured to rotate in response to a flow of wellbore fluid across the blades; and
an oleophobic coating disposed at least partially on the hub and the plurality of pitched blades; and
determining, from a speed of rotation of the blades, a velocity of the flow.

17. The method of claim 16, further comprising disposing the oleophobic coating on the hub and the plurality of pitched blades.

18. The method of claim 16, wherein the oleophobic coating comprises poly (diallyldimethylammonium).

19. The method of claim 16, wherein the oleophobic coating comprises poly (styrene sulfonate).

20. The method of claim 16, wherein the oleophobic coating comprises particles with sizes of less than about 100 nanometers.

21. The method of claim 16, wherein the oleophobic coating comprises particles of about 1 nanometer in size.
